(19) United States
(12) Patent Application Publication
(10) Pub. No.: US 2003/0089709 A1
(43) Pub. Date: May 15, 2003

(54) Microwave oven

(76) Inventors: Sergio Corumba Dos Santos, Ribeirao (BR); Antonio Jorge Pietruza, Joinville (BR); Guilherme Nehring, Joinville (BR)

Correspondence Address: Joseph R Robinson, Darby & Darby, Post Office Box 5257, New York, NY, 10150-5257, US

(21) Appl. No.: 10/220,157

(22) PCT Filed: Feb. 6, 2001
(86) PCT No.: PCT/BR01/00017

(30) Foreign Application Priority Data
Feb. 23, 2000 (BR) PI0001932-1

(51) Int. Cl. H05B 6/64

(52) U.S. Cl. 219/756; 219/754

(57) ABSTRACT

A microwave oven comprising a usually prismatic cabinet (10) having a bottom wall (11) and a door (20), and defining, internally, a cooking chamber, in which is provided a turntable (40), the upper edge (13) of the cabinet (10) surrounding an opening (14), against which is seated and releasably locked the door (20), said upper edge (13) or said door (20) carrying a control panel (50) for the operation of the microwave oven. The door (20) may be operatively coupled to the turntable (40) so as to vertically displace the latter upon movement of said door (20).

### FIELD OF THE INVENTION

The present invention refers to a new construction applied to a microwave oven, of the type in which the access to the inside of the cooking chamber is achieved by means of a door, which is usually hingedly provided on the front panel of the appliance.

### BACKGROUND OF THE INVENTION

There are known in the art and widely used the microwave ovens usually comprising a parallepipedic cabinet, whose inside is accessed by the user through a front door, which is articulated by a lateral hinge or by a lower horizontal hinge and mounted to the front wall of said cabinet.

These parallepipedic cabinets are usually seated on counters, shelves or supports, which are affixed to walls of a respective room of a building, at a height that makes easy for the user to access the inside of the microwave oven, by opening its front door.

While being commonly used, these microwave ovens with a front door have the inconvenience of requiring the user to take out from the microwave oven the container containing the food to be prepared, every time he/she needs to intervene in the preparation of the food, such as, for example, for seasoning, or even for simply stirring the food with a spoon during the cooking process. This procedure, besides taking more time, exposes the user to accidents, such as sprinkles of the product or tilting of the container, which in these interferences is generally removed from the inside of the microwave oven.

### DISCLOSURE OF THE INVENTION

Thus, it is an object of the present invention to provide a microwave oven having a door, which is positioned in such a way as to allow the user to easily and completely access the food or product being processed, without requiring the displacement of said food or product out from said microwave oven.

It order to achieve the objective above, there is provided a microwave oven comprising a usually prismatic cabinet, having a bottom wall and a door, and defining, internally, a cooking chamber in which is provided a turntable.

According to the invention, the cabinet has an upper edge surrounding an opening, against which is seated and releasably locked the door, said upper edge or said door carrying a control panel for the operation of the microwave oven.

### BRIEF DESCRIPTION OF THE DRAWINGS

The invention will be described below, with reference to the attached drawings, in which:

FIG. 1 is a front lateral upper perspective view of a possible embodiment of the microwave oven of the present invention;

FIG. 2 is a front elevational view of the microwave oven of FIG. 1;

FIG. 3 is an upper plan view of the microwave oven of FIGS. 1 and 2;

FIG. 4 is a rear elevational view of the microwave oven of FIGS. 1-3;

FIG. 5 is a lateral elevational view of the microwave oven of FIGS. 1-4; and

FIGS. 6 and 7 are cross-sectional views of the microwave ovens of the previous figures, said views being taken according to lines VI-VI and VII-VII in FIG. 3.

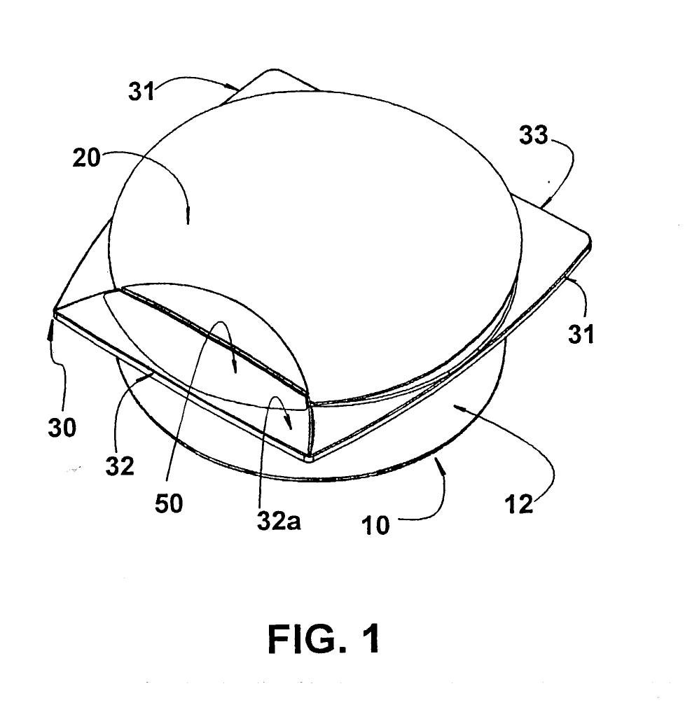

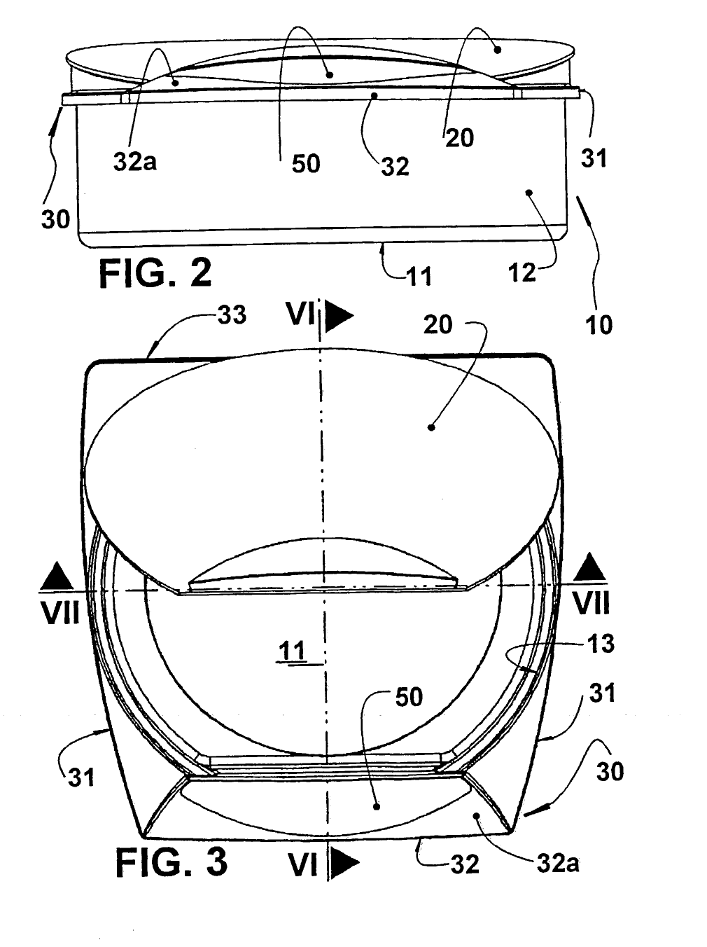

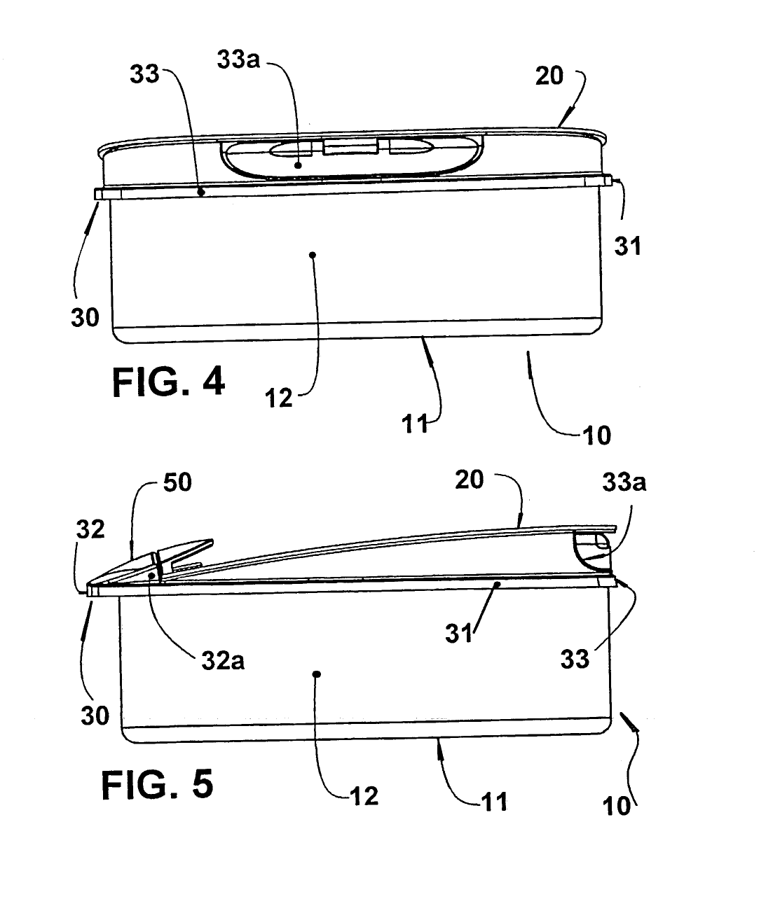

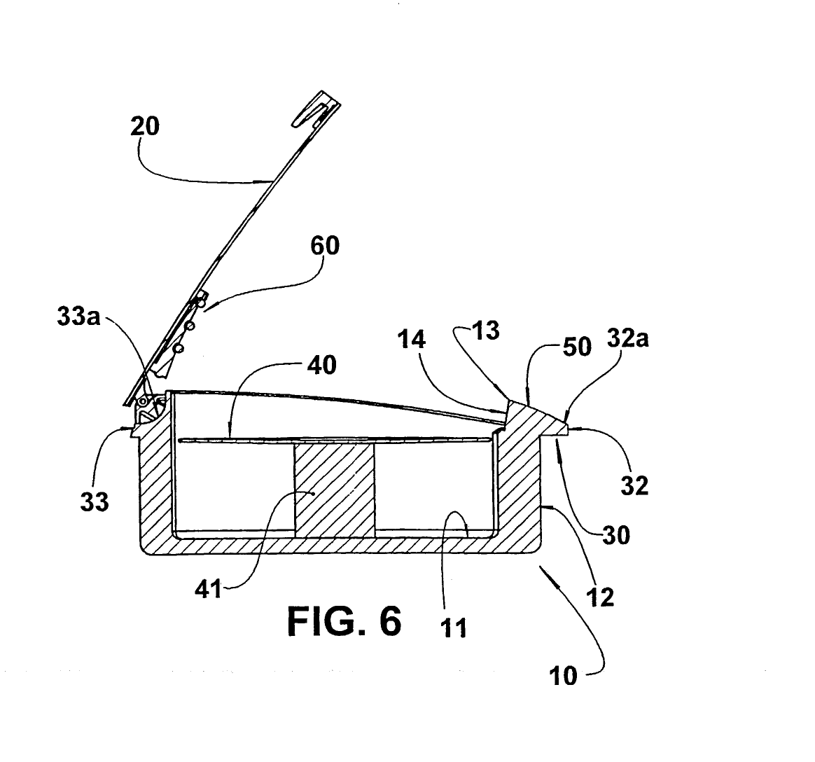

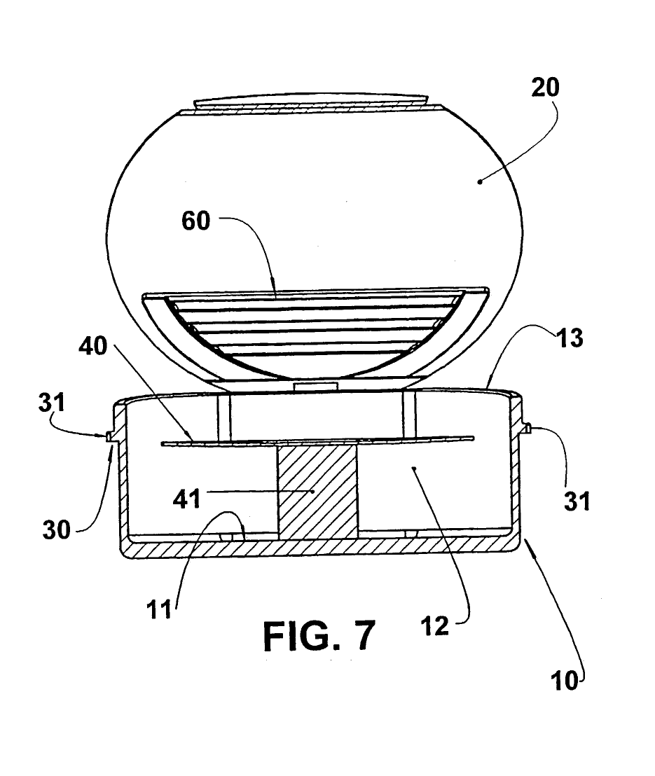

### BEST MODE OF CARRYING OUT THE INVENTION

According to the illustrations mentioned above, the present microwave oven comprises a cabinet 10, having a bottom wall 11, a lateral wall 12, which is continuous and preferably cylindrical, and an upper edge 13 surrounding an opening 14, which allows the user to access the cooking chamber defined inside the cabinet 10, said opening 14 being selectively closed by a door 20, which is articulated to the upper edge 13 of the cabinet 10. It should be understood that both the cabinet 10 and the door 20 may have shapes different from those illustrated, as long as they are capable of providing the respective functions of defining a cooking chamber and the selective closing of the door.

In the illustrated construction, the cabinet 10 incorporates, in the region of its upper edge 13, an external peripheral flange 30 to be seated onto a horizontal surface (not illustrated), through which is mounted said microwave oven. Said horizontal surface is generally defined by a working counter in the environment where the microwave oven will be installed, such as a kitchen counter.

In situations in which the external peripheral flange 30 has the function of sustaining the cabinet, by seating the latter on said horizontal surface, the external peripheral flange 30 is rigidly and securely affixed or incorporated to the lateral wall 12 of the cabinet 10. It should be understood, however, that this external peripheral flange 30 may have only the function of promoting the finishing for the mounting of said microwave oven onto said horizontal surface through which it is installed, in which case the external peripheral flange 30 functions as a finishing ring or cap, and need not be affixed or otherwise incorporated to the lateral wall 12 of the cabinet 10. In this case, the mounting of the cabinet 10 may be effected, for example, by supporting its bottom wall 11.

The cabinet 10 may also be mounted in a non-embedded way, on a horizontal surface as described above, in which case said cabinet 10 is laterally visible and supported by its bottom wall 11, for example.

It should be further observed that the external peripheral flange 30 need not be a whole continuous piece, i.e., defined by a single extension of the external peripheral flange. There may be provided two or more extensions of the external peripheral flange, which are preferably coplanar to each other, in order to define supporting points on said horizontal surface, through which is mounted the microwave oven. According to the preferred illustrated construction, the external peripheral flange 30 has a trapezoidal contour, with opposite convex sides 31, with a front smaller base 32 carrying a control panel 50 for the microwave oven on part of its front surface which, according to the preferred embodiment, is defined by a ramp 32a, and with a rear larger base 33 hingedly affixing, on part of its front surface defined by a concave portion 33a, a corresponding edge of the door 20 that is angularly displaced from an open oven position, in which it is positioned substantially orthogonal to the external peripheral flange 30, to a closed oven position, in which it is seated and locked against the opening 14, which is provided in said flange 30 in order to give access to the inside of the cabinet 10.

With the constructive arrangement defined above, the access to the inside of the microwave oven is now achieved through the upper opening 14 of the cabinet 10.

The cabinet 10 is defined, according to the preferred embodiment, by a hollow cylindrical body, with its bottom wall 11 carrying a vertical rod 41 supporting the turntable 40, which may be operatively coupled to the door 20 in order to be upwardly and downwardly displaced, through said vertical rod 41, from an operative position, adjacent to said bottom wall 11, to an exposure position, substantially coplanar to the upper edge 13 of the cabinet 10, when the door 20 is angularly displaced from the closed oven position to the open oven position.

The vertical axial movement of the turntable 40 may be further obtained by driving means other than the door 20.

As illustrated, the door 20 may carry, internally, a heat irradiating means 60, in order to brown or gratinate the food, or even the control panel 50 in its structure.

With this preferred construction, the user can interfere directly in the processing of the food, without having to remove the container from the inside of the oven, making easier the handling of the product being processed and avoiding possible accidents due to sprinkles of the product or tilting of the container, which generally occur with the successive insertions and removals of the recipients in and out from the known microwave ovens.

1. A microwave oven comprising a usually prismatic cabinet (10), having a bottom wall (11) and a door (20), and defining, internally, a cooking chamber in which is provided a turntable (40), characterized in that the cabinet (10) has an upper edge (13) surrounding an opening (14), against which is seated and releasably locked the door (20), a control panel (50) for the operation of the microwave oven being provided in one of the parts defined by the door (20) and the upper edge (13).

2. The microwave oven according to claim 1, characterized in that the cabinet (10) carries at least one extension of a peripheral external flange (30) to be seated onto a horizontal surface, through which the microwave oven is mounted.

3. The microwave oven according to claim 2, characterized in that the peripheral external flange (30) is incorporated to the upper edge (13) of the cabinet (10).

4. The microwave oven according to any one of the claims 1, 2, or 3, characterized in that the turntable (40) is axially and selectively displaced, both upwardly and downwardly, from an operative position, adjacent to the bottom wall (11) of the cabinet (10), to an exposure position, substantially coplanar to the upper edge (13) of the cabinet (10).

5. The microwave oven according to claim 4, characterized in that the door (20) is operatively coupled to the turntable (40), in order to promote the axial displacement of the latter between the operative and exposure positions, when said door (20) is displaced between a closed oven position, seated on said opening (14) of the cabinet (10), and an open oven position, spaced from said opening (14), liberating the access to the inside of the cabinet (10).

6. The microwave oven according to any one of the preceding claims, characterized in that the door (20) is hinged to the cabinet (10), in order to be angularly displaced between its closed oven position and open oven position.

7. The microwave oven according to any one of the preceding claims, characterized in that the cabinet (10) is substantially cylindrical.

8. The microwave oven according to any one of the preceding claims, characterized in that the door (20) carries, internally, a heat irradiating means (60) in order to brown or gratinate the food.
